(19) United States
(12) Patent Application Publication
(10) Pub. No.: US 2008/0286025 A1
(43) Pub. Date: Nov. 20, 2008

(54) Mobile messaging micro-printer

(76) Inventors: Christopher B. Wright, San Francisco, CA (US); Joseph H. Wright, III, Toronto (CA)

Correspondence Address: DERGOSITS & NOAH LLP, FOUR EMBARCADERO CENTER, SUITE 1450, SAN FRANCISCO, CA, 94111, US

(21) Appl. No.: 11/800,401

(22) Filed: May 4, 2007

Related U.S. Application Data
(60) Provisional application No. 60/798,117, filed on May 4, 2006.

(51) Int. Cl. B41J 3/36; B41J 3/32

(52) U.S. Cl. 400/88; 400/109.1

(57) ABSTRACT

A mobile micro-printer delivers and prints incoming messages and text instantly and privately in hard copy on paper or pre-treated plastic and is compatible with cell phones and smart phones. It provides for instant or text messaging from computers, laptops, PDAs, cell or smart phones and other platforms to a user's cell or smart phone to the micro-printer. The mobile micro-printer incorporates a variety of wireless technologies. It can be fully automatic and wireless and can be clipped to a belt, clipped to a strap, or tucked away within each reach. It can produce hard copy messages in viewable text, in Braille, or in a combination of both.

### PRIOR APPLICATIONS

This application claims priority to U.S. Provisional Patent Application Ser. No. 60/798,117 filed May 4, 2006.

### BACKGROUND OF THE INVENTION

Instant messaging, text messaging and numeric paging provide rapid modes of mobile communications. However, there is no simple, permanent record provided for these types of messages, received wirelessly, in a mobile environment. In some situations a copy of the text is desirable when trying to keep a phone number, address, directions or a scheduled meeting.

### SUMMARY OF THE INVENTION

A very small, wearable, mobile micro-printer delivers incoming instant and text messages instantly and privately in hard copy on paper or pre-treated printable plastic. The micro-printer can be used with cell phones, smart phones, computers, laptops, tablets, personal digital assistants (PDAs), computers, Global Positioning Systems (GPS), pagers and any other communications or information electronic devices. Alternatively, the micro-printer can be used independently to print information without any other electronic devices and may also include a transmitter for sending outgoing messages. The micro-printer allows a user to selectively print any desired information.

In an embodiment, the micro-printer is used with a cell phone, the micro-printer provides for physical copies of information transmitted via instant messaging, text messaging and caller ID. In addition to received information, the micro-printer may also be able to print information from the phone's internal memory. The mobile micro-printer incorporates wireless receiver technology (Bluetooth, for example) and can be set to automatically receive and print instant and text messages as they are generated and/or received by a user's cell or smart phone. It can be clipped to a belt, clipped to a strap, or tucked away within easy reach.

In an alternative embodiment, the mobile micro-printer can also be equipped to receive messages directly so that an intermediary cell or smart phone or other initial intermediary receiving device is not required or be integrated with the cell phone. In this alternative mode the mobile micro-printer is equipped with a unique cellular address, IP address, or high speed wireless EVDO interface, allowing independent and direct receipt of instant or text messages or other brief text addressed to it. Or, it can be equipped with a wireless RF interface that allows the micro-printer independent and direct access to the Internet for receipt of instant or text messages or other brief text directed to it. In another alternative, the mobile micro-printer incorporates a Braille printer for the blind and partially sighted, allowing the blind and partially sighted to participate in mobile receipt of instant and text messages as well as receipt of other brief text.

The micro-printer can be a stand alone device with its own phone number or IP address so that messages can be directly routed. The micro-printer may further include an input device such as a keypad and/or microphone. The user can create text messages with the keypad and transmit these messages from the micro-printer. If audio information is input through the microphone, the micro-printer can function as a cell phone or a voice recognition system can translate the audio signals into text messages that can then be transmitted through the Internet to the target recipients.

### BRIEF DESCRIPTION OF THE FIGURES

The invention is herein described, by way of example only, with reference to embodiments of the present invention illustrated in the accompanying drawings.

FIG. 1 is a top sectional view of an embodiment of the mobile messaging printer.

FIG. 2 is a rear view of an embodiment of the mobile messaging printer.

FIG. 3 is a front view of an embodiment of the mobile messaging printer.

FIG. 4 is a view of the Braille output of the mobile messaging printer.

FIG. 5 is a view of the Braille and printed text output of the mobile messaging printer.

FIG. 6 shows the mobile messaging printer used with an electronic device and a network.

FIG. 7 illustrates the mobile messaging printer used as a stand alone device with a visual display.

FIG. 8 illustrates the mobile messaging printer used as a stand alone device with a visual display and text input devices.

### DETAILED DESCRIPTION OF THE INVENTION

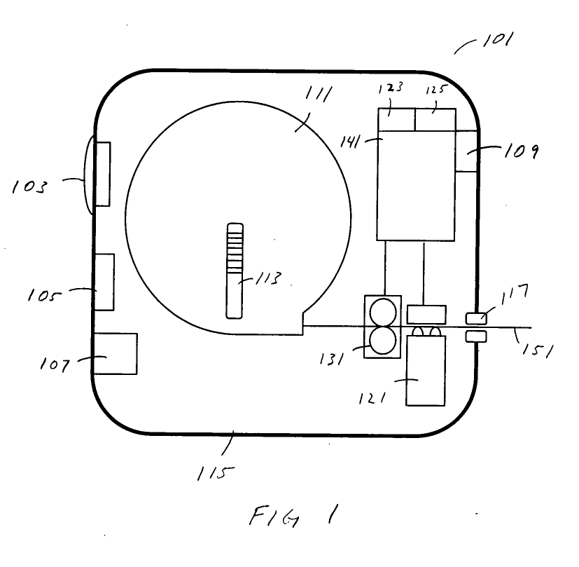

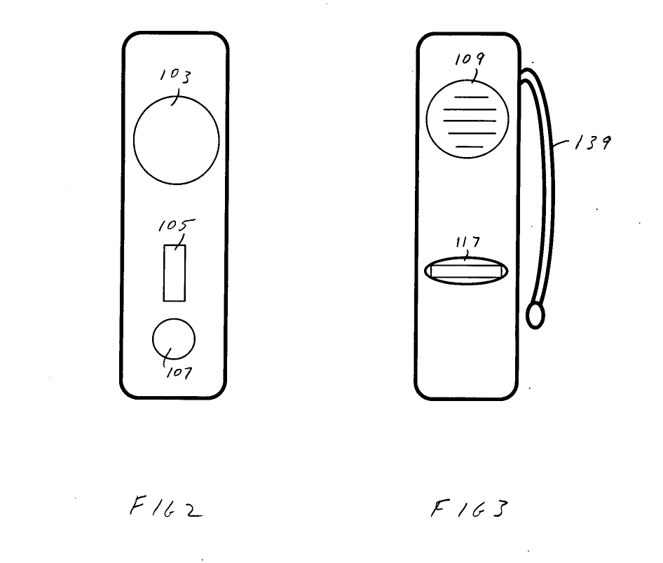

With reference to FIGS. 1, 2 and 3, the components of an embodiment of the mobile micro-printer 101 are illustrated. The micro-printer 101 can have various components including; a housing 115, an internal rechargeable battery 123, a wireless receiver or transceiver 125, a charging port 107, an electronic communications port 105, an on/off button 103, a speaker 109, a microprocessor 141, capstan 131 and print head 121. The on/off switch 103 is coupled to the battery 123 and controls the output of power to the micro-printer. The batter 123 can be recharged through a charging port which supplied electrical power to the battery 123 from an external source. When the on/off 103 switch is turned on, power is supplied to the microprocessor 141 which controls the operation of the micro-printer 101.

In the preferred embodiment, the micro-printer 101 is a very small hand held device that can be easily carried with other small objects such as cell phones, PDAs, keys, wallets, etc. In one configuration the mobile micro-printer 101 can include a clip 139 which allows it to be worn on a belt or clipped to a strap for more convenient transportation by the user. In order to be easily portable, the micro-printer should be very small in size. In an embodiment, the micro-printer may have dimensions of about one to four inches wide, one to four inches long and one half to two inches thick.

The micro-printer 101 holds a supply of the print material 151 or alternatively, the print material 151 can be stored in a cassette 111 that contains the print material 151. In an embodiment, the print material 151 is wound on a reel within the cassette 111. The cassette 111 may have a window 113 that allows the user to see how much print material is left 151. The cassette 111 also has a slot that allows the print material 151 to exit the cassette 111. The micro-printer 101 may have a door that holds the cassette 111 within the housing 115 or alternatively, the cassette 111 might be inserted through a slot in the housing 115.

In an embodiment, the print material 151 can be pulled from the cassette 111 by a capstan 131 mechanism which includes two rotating rollers and an electric motor. The print material 151 passes between the rollers that are configured to apply a slight pressure against each other. The friction of the rollers against the print material 151 causes the print material 151 to be removed from the cassette 111. Once the print material 151 depleted from the cassette 111, it can be removed and a replacement cassette 111 can be inserted. The capstan motor is coupled to a microprocessor 141 that controls the operation of the capstan 131. In other embodiments, any other mechanism can be used to pull the print material 151 from the cassette such as belts, a motor drive applied to a hub in the cassette, etc.

From the material movement mechanism, the print material 151 is directed to the printing mechanism 121. The mobile micro-printer 101 print mechanism is preferably a miniature thermal printer, but may also be a Braille impact printer, a heat driven raising chemical dot printer, or a combination of impact and thermal print technologies. In the preferred embodiments, a thermal printer provides viewable text, while a Braille impact and/or raising chemical dot printer provide text in a Braille format. The micro-printer 101 can have a plurality of print mechanisms that would allow a user to selectively activate the desired print output or combination of print outputs.

In a visual ink printing embodiment, the print head includes an array of tiny electrically heated chambers that emit small droplets of ink. To produce an image, the printer runs a pulse of current through the heating elements. An ink bubble form in the chamber which propels a droplet of ink onto the paper. The chambers are coupled to an ink reservoir. By coordinating the movement of the paper and the emission of ink from the print head, images are formed on the paper.

Alternatively, the print head can be a thermal print head. In this embodiment, the print material must be thermo-sensitive paper. The paper material may be impregnated with a solid-state mixture of a dye and a suitable matrix. When the matrix is heated above its melting point, the dye reacts with the acid, shifts to its colored form. The changed form is then conserved in metastable state when the matrix solidifies back quickly enough. To create images, an electric current is sent to a heating resistor in the thermal print head which generates heat in a prescribed pattern. The heat activates the thermo-sensitive coloring layer of the thermo-sensitive paper, which changes color in response to the patterned heat.

In an embodiment, the print head can be a Braille embosser which includes impact pins that impact the print material to form protrusions from the plane of the material. Alternatively, the raised dot features may be formed through a reaction with the print material. For example, the print head may emit a liquid that causes the corresponding circular section to swell and harden to form a raised area or a cutter or laser may be used to form holes rather than raised features in the print material.

For Braille text, each character is formed by an arrangement of dot protrusions that can occupy any of six spaces in a two column, three row array. These positions are each given a number and the letters are formed by forming the dots in the required positions. When printing Braille messages, the print material is positioned over a six pin impact head and the pins associated with the letter are actuated to form the desired markings. Alternatively, the print material may be positioned adjacent to a fluid jet mechanism that sprays a reactive fluid onto the print material to form the textured markings. The capstan then moves the print material a distance and stops for the next figure to be formed by the print head.

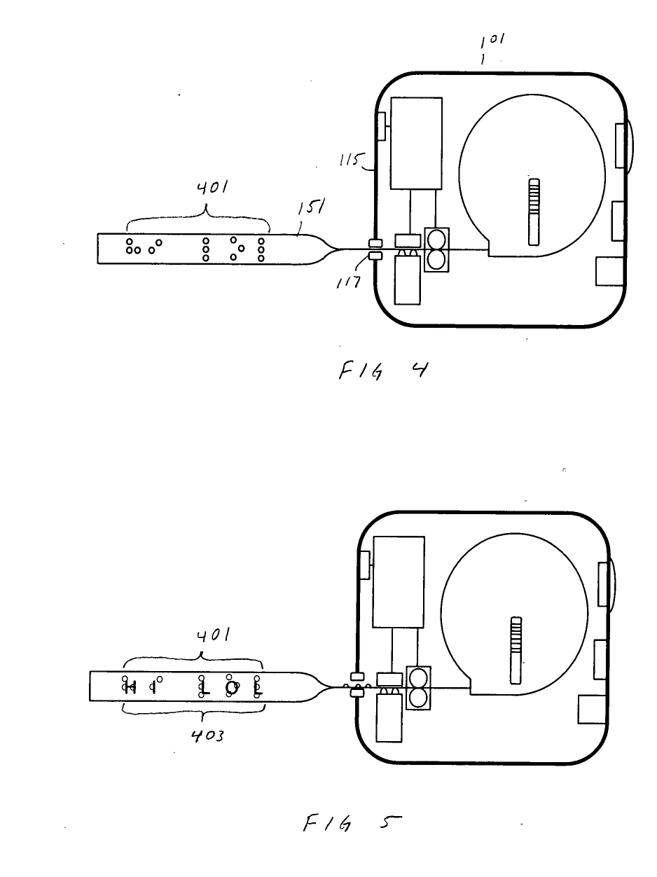

With reference to FIGS. 4 and 5, the print material 151 exits the housing 115 through a slot 117 that may include a material cutter, that allows the user to tear off the printed portions of the print material 151. The print material can have a textured output such as Braille text as shown in FIG. 4. In an embodiment, the micro-printer 101 can be configured to print both visible text in addition to the Braille text as shown in FIG. 5. Similarly, the textured output can be turned off so that only visible text is printed. The combination of textured and visible text allows messages to be shared with people who cannot read Braille.

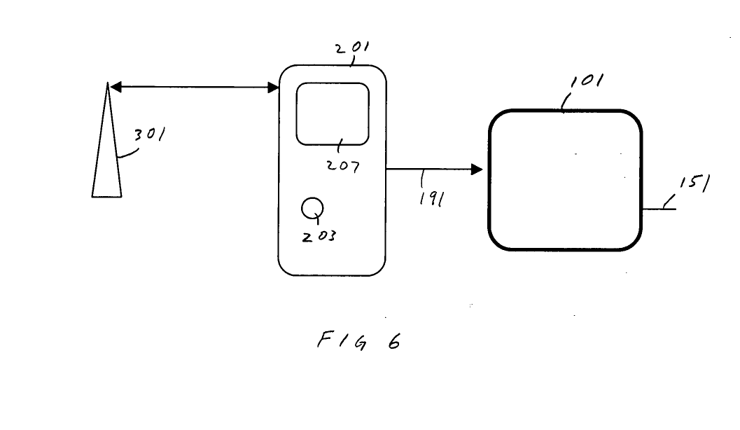

The micro-printer can be used alone or in combination with other portable electronic devices. With reference to FIG. 6, the user of the micro-printer 101 with an electronic device such as a cell phone 201 is illustrated. Many cell phones 201 are capable to text messaging. When used with a cell phone 201, the text messages are transmitted to and from the cell phone 201 through a network 301 and displayed on a visual display 207. When the user wishes to print some or all of the text, a control 203 on the cell phone 201 is activated to transmit the message to the micro-printer 101. Once the desired information is printed, the control 203 can be deactivated to stop printing.

The communications link 191 between the micro-printer 101 and the cell phone 201 can be through a wired connection or a wireless connection. An example of a hardwired connection is a USB connection, however any other type of wired connection can be used. With wireless communications, the text can be transmitted from the cell phone 201 to the micro-printer 101 via radio frequency signals that can be in a standard industry specification such as Bluetooth. The message signals are processed by the microprocessor which directs the print material feeder and print head to print the messages onto the print material 151. The micro-printer 101 may also respond by emitting an audible signal or provide visual signal indicating that a message has been received and is being printed. In other embodiments, any other type of portable electronic device can be used in place of the cell phone 201, such as a computer, pager, gps, RF communicator, satellite radio, etc.

With reference to FIG. 7, in other embodiments, the micro-printer 701 may receive messages independently of any other electronic device. Since Bluetooth is only suitable for communications between devices in close proximity, a longer range communications system should be used such as cell phone technology, smart phone technology, WiFi, WiMax Internet technology or other wireless technology. In these embodiments, the micro-printer 701 has an appropriate receiver that obtains the message from the communications network 301 and the microprocessor directs the feeder and print head to print the messages. In these embodiments, the micro-printer 701 can have its own IP address for an Internet connection, either wireless or through a port such as the USB or Ethernet or a telephone number so that the device can be located on a telephone network.

In an embodiment, the micro-printer includes mechanisms for controlling the information that is printed on the print material 751. The micro-printer may include an electronic memory that stores messages and visual display 703 that shows the text of the received and/or transmitted messages that are stored in the memory. During or after the communications, the user can then use a controller 705 to indicate which text to print. In this example, the selected print is underlined in the visual display, “doctor's appointment at 123 pine @ 2:00 pm.” In other embodiments the selected text can be indicated by altering the appearance of the selected text through various possible means such as altering the color, font, background, etc. Once the desired text is selected, the user can press a print button 707 which causes the selected text to be printed on the print material 751.

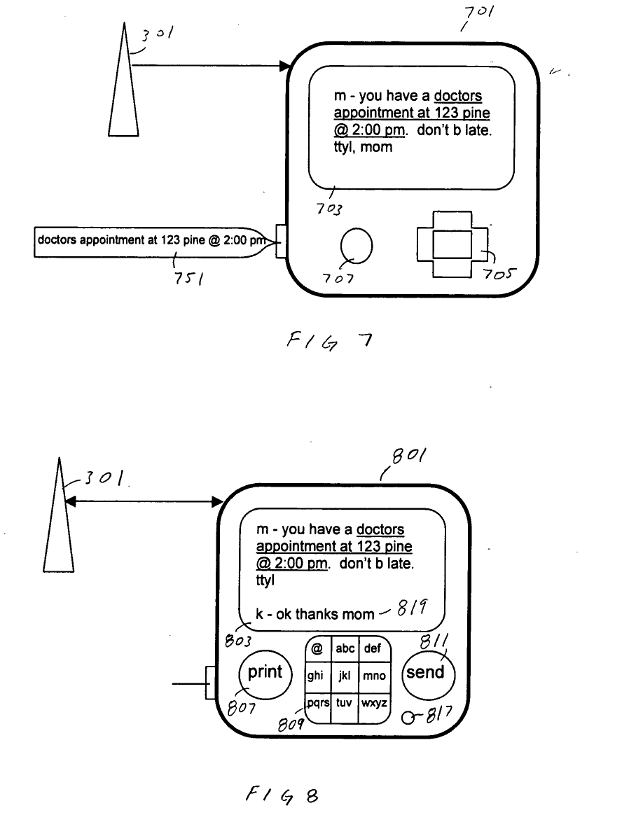

In yet another embodiment, as illustrated in FIG. 8, the micro-printer 801 operates as a stand alone device and has a visual display 803, an input device 809 for creating text messages and a transmitter for transmitting the messages to the network 301 for delivery to a specific recipient. In this embodiment, the user can receive messages and respond using the input device 809. The input device can be a keypad 809 that allows users to input letters that are then displayed on the visual display 803. Alternatively or in addition to the keypad 809, the input device may be a microphone 817 that is coupled to a voice recognition system that converts the users voice into corresponding text 819 that can be displayed on the visual display 803 and then transmitted as a text message when the sent button is pressed 811. If the user wishes to change the message before sending, the message can be deleted and the user can create a new message. The user can store the messages in memory and selectively print desired sections from the messages by indicating the text to print and pressing the print button 807.

In other embodiments, the micro-printer may include additional features such as cell phone capability for making and receiving phone calls, telephone answering machine that would respond to incoming calls with a message and then allow the caller to record a message, pager that allows phone numbers and brief text messages to be displayed or any other electronic device so that devices can receive and print instant or text messages or other brief text information. The micro-printer can be built into an automobile or truck dashboard or any other device that is regularly used to provide hard copy receipts of brief messages. The micro-printer may be a modular device that fits into existing device ports in an electronic device. For example, many laptop computers include PCMCIA ports. In an embodiment, the inventive micro-printer can be coupled to the laptop by inserted the micro-printer into the PCMCIA port.

While the present invention has been described in terms of a preferred embodiment above, those skilled in the art will readily appreciate that numerous modifications, substitutions and additions may be made to the disclosed embodiment without departing from the spirit and scope of the present invention. Those skilled in the art will readily appreciate that the present invention is in no way limited to mechanisms described above. For example, the mobile micro-printer is preferably used to print text messages. However, it may also be configured to print bar codes, micro images, receipts, forms and other brief documents. It is intended that all such modifications, substitutions and additions fall within the scope of the present invention which is best defined by the claims below.

What is claimed is:

1. A portable electronic printer comprising:
a radio frequency receiver for receiving messages;
a microprocessor for converting the messages into text;
a print material that is wound on a reel;
a print head that creates features representing the text on the print material; and
a capstan that feeds the print material to the print head from the reel.

2. The portable electronic printer of claim 1 wherein the print head is an embossing mechanism that forms Braille letters on the print material.

3. The portable electronic printer of claim 1 further comprising:
a speaker that emits a signal when the print messages are received by the radio frequency receiver.

4. The portable electronic printer of claim 1 further comprising:
a cartridge that holds the print material wound on the reel; and
a housing that includes a cartridge holder and slot that the print material exits through after it has been marked by the print head.

5. The portable electronic printer of claim 1 wherein the print head includes a heat source and creates text markings on the print material which is heat sensitive.

6. The portable electronic printer of claim 1 further comprising:
ink reservoir coupled to the print head;
wherein the print head creates ink markings on the print material.

7. A portable electronic communications device comprising:
a radio frequency receiver for receiving messages from a network;
a conversion module for converting the messages into text;
a print material that is wound on a reel;
a print head that creates features representing the text on the print material;
a feed mechanism that moves the print material to the print head from the reel;
a microphone for receiving audio signals from a user;
a voice recognition module for converting the audio signals into text signals; and
a transmitter for transmitting the text signals to the network.

8. The portable electronic printer of claim 7 wherein the print head is an embossing mechanism that forms Braille letters on the print material.

9. The portable electronic printer of claim 7 further comprising:
a speaker that emits a signal when the messages are received by the radio frequency receiver.

10. The portable electronic printer of claim 7 further comprising:
a cartridge that holds the print material wound on the reel; and
a housing that includes a cartridge holder and slot that the print material exits through after it has been marked by the print head.

11. The portable electronic printer of claim 7 wherein the print head includes a heat source and creates text markings on the print material which is heat sensitive.

12. The portable electronic printer of claim 7 further comprising:
ink reservoir coupled to the print head;
wherein the print head creates ink markings on the print material.
